(19) United States
(12) Patent Application Publication
(10) Pub. No.: US 2009/0219242 A1
(43) Pub. Date: Sep. 3, 2009

(54) LIQUID CRYSTAL DISPLAY DEVICE, LIQUID CRYSTAL PANEL CONTROLLER, AND TIMING CONTROLLER

(76) Inventors: Yuki Fuchigami, Osaka (JP); Osamu Sarai, Osaka (JP); Toru Matsugi, Osaka (JP)

Correspondence Address: MCDERMOTT WILL & EMERY LLP, 600 13TH STREET, NW, WASHINGTON, DC, 20005-3096, US

(21) Appl. No.: 12/389,877

(22) Filed: Feb. 20, 2009

(30) Foreign Application Priority Data
Feb. 28, 2008 (JP) 2008-047066

(51) Int. Cl. G09G 3/36

(52) U.S. Cl. 345/100

(57) ABSTRACT

In a LCD device, deterioration in display quality due to the difference of the line resistances of scan-line control signal lines is prevented by a simple structure. A gate driver outputs, from respective output terminals connected to scan-line control signal lines of a liquid crystal panel, a panel control pulse for turning on a TFT. A timing control circuit outputs to the gate driver an output enable signal for controlling an output timing of the panel control pulse. The output enable signal includes an enable control pulse for enabling the panel control pulse to be output. The timing control circuit is capable of adjusting the pulse width of the enable control pulse in accordance with the output terminals of the gate driver.

### CROSS-REFERENCE TO RELATED APPLICATIONS

This application claims priority from Japanese Patent Application No. 2008-047066 filed on Feb. 28, 2008, which is hereby incorporated by reference in its entirety for all purposes.

### BACKGROUND

The disclosure of this specification relates generally to liquid crystal display (LCD) devices and specifically to control of scan-line control signals for a liquid crystal panel.

In the recent years of LCD technology, achievement of higher definition and larger panel size is accompanied by increase in the number of scan lines in the liquid crystal panels. Meanwhile, the number of parts included in a driver circuit of a LCD device is decreasing for the purpose of reducing the cost of production. Among others, the gate driver, which controls switching of transistors of a liquid crystal panel, is designed to control a larger number of outputs while the number of parts of the driver circuit is reduced.

Typical examples of such conventional LCD devices are disclosed in Japanese Laid-Open Patent Publications Nos. 2006-259721 and 2007-178784.

### SUMMARY

With a larger number of output terminals in the gate driver, the lines for control signals that control the scan lines (scan-line control signal lines), extending from the respective output terminals to the liquid crystal panel, have different lengths and therefore have different wire loads. Accordingly, among the scan lines, the control signals supplied to the liquid crystal panel disadvantageously have greatly different pulse widths.

FIG. 8 shows part of a LCD device, including a liquid crystal panel 11 and a gate driver 12. The liquid crystal panel 11 and the gate driver 12 are connected by scan-line control signal lines G1 to G4 which have line resistances R1 to R4, respectively. In the example of FIG. 8, the scan-line control signal lines G1 to G4 have different lengths, and the line resistances R1 to R4 have the relationship of R1>R2>R3>R4. The time for the panel control pulses output from the gate driver 12 to rise to the ON level of thin film transistors (TFTs) of the liquid crystal panel 11 is affected by the line resistances R1 to R4 of the scan-line control signal lines G1 to G4. For example, the scan-line control signal line G1 having the largest line resistance R1 has slower rising of the pulse, while the scan-line control signal line G4 having the smallest line resistance R4 has faster rising of the pulse as compared with the scan-line control signal line G1. As a result, among the scan-line control signal lines G1 to G4, the scan-line control signals have different pulse widths, i.e., fail to have equal pulse widths.

Thus, among the scan lines of the liquid crystal panel, the scan-line control signals have different pulse widths due to the difference of the line resistances of the scan-line control signal lines. As a result, an image displayed over the liquid crystal panel has unevenness, e.g., unintended gradation of shade, which deteriorates the display quality.

A conventional solution to such a problem is, for example, varying the wire widths of the scan-line control signal lines, among the output terminals of the gate driver, such that the wire loads are equal. This solution however causes difficulties in device designing and manufacturing processes and therefore lacks versatility and increases the production cost. Another solution is a resistance adjusting circuit provided in a power supply line that supplies an output voltage to the gate driver, for equalizing the wire loads (see Japanese Laid-Open Patent Publication No. 2005-165034). This solution however increases the production cost due to an increased number of parts and impedes size reduction of the device.

The present invention may advantageously provide a LCD device having a simple structure which can prevent the deterioration in display quality due to the difference of the line resistances of the scan-line control signal lines.

The present invention may provide a LCD device including: an active matrix liquid crystal panel; a gate driver having a plurality of output terminals connected to scan-line control signal lines of the liquid crystal panel, the gate driver outputting from the output terminals a panel control pulse for turning on a TFT of the liquid crystal panel; and a timing control circuit outputting to the gate driver an output enable signal for controlling an output timing of the panel control pulse, wherein the output enable signal includes an enable control pulse for enabling the panel control pulse to be output, and the timing control circuit is capable of adjusting a pulse width of the enable control pulse in accordance with the output terminals of the gate driver.

In the LCD device, the panel control pulse output from the respective output terminals of the gate driver is controlled as to its output timing according to the output enable signal from the timing control circuit. In the timing control circuit, the pulse width of the enable control pulse included in the output enable signal is adjustable in accordance with the output terminals of the gate driver. Therefore, even when the scan-line control signal lines have different line resistances, the pulse width of the enable control pulse is adjusted in accordance with the output terminals of the gate driver such that the control signals applied to the scan lines of the liquid crystal panel may have equal pulse widths. Thus, unevenness in display can be prevented and, accordingly, deterioration in display quality can be prevented. Further, cost-increasing solutions, e.g., adjusting the line width of the scan-line control signal lines and adding a resistance adjusting circuit, are not necessary.

In the LCD device, preferably, the timing control circuit includes a counter for counting a scan-line shift clock signal. The timing control circuit identifies an output terminal of the gate driver from which the panel control pulse is output based on a value counted by the counter and adjusts the pulse width of the enable control pulse in accordance with the identified output terminal.

The timing control circuit may receive the scan-line shift clock signal from an external device. Alternatively, the timing control circuit may include a scan-line shift control signal generating circuit which receives a vertical synchronization signal and a horizontal synchronization signal for the liquid crystal panel to generate the scan-line shift clock signal.

In the LCD device, the timing control circuit may sort the output terminals of the gate driver into groups each including two or more output terminals and adjust the pulse width of the enable control pulse for each of the groups.

In the LCD device, the timing control circuit preferably adjusts the enable control pulse such that the enable control pulse has a longer pulse width as the length of a scan-line control signal line connected to a corresponding output terminal becomes greater.

The present invention may also provide a liquid crystal panel controller for controlling an active matrix liquid crystal panel. The liquid crystal panel controller includes: a gate driver having a plurality of output terminals connected to scan-line control signal lines of the liquid crystal panel, the gate driver outputting from the output terminals a panel control pulse for turning on a TFT of the liquid crystal panel; and a timing control circuit outputting to the gate driver an output enable signal for controlling an output timing of the panel control pulse, wherein the output enable signal includes an enable control pulse for enabling the panel control pulse to be output, and the timing control circuit is capable of adjusting a pulse width of the enable control pulse in accordance with the output terminals of the gate driver.

The present invention may also provide a timing control circuit for controlling an operation timing of a gate driver that controls an active matrix liquid crystal panel, wherein: the gate driver has a plurality of output terminals connected to scan-line control signal lines of the liquid crystal panel, the gate driver outputting from the output terminals a panel control pulse for turning on a TFT of the liquid crystal panel; and wherein the timing control circuit outputs to the gate driver an output enable signal for controlling an output timing of the panel control pulse, the output enable signal including an enable control pulse for enabling the panel control pulse to be output, and the timing control circuit is capable of adjusting a pulse width of the enable control pulse in accordance with the output terminals of the gate driver.

Thus, advantageously, pulses applied to the respective scan lines of the liquid crystal panel can have equal pulse widths even when the scan-line control signal lines have different line resistances. As a result, occurrence of unevenness in display can be prevented. Therefore, a LCD device of high picture quality can be achieved.

### BRIEF DESCRIPTION OF THE DRAWINGS

FIG. 1 is a block diagram showing the structure of a LCD device of embodiment 1.

FIG. 2 is a timing chart illustrating an operation example of the LCD device of embodiment 1.

FIG. 3 is a timing chart illustrating how to generate an output enable signal.

FIG. 4 is a timing chart of a comparative example.

FIG. 5 is a block diagram showing a structure including a plurality of gate drivers.

FIG. 6 is a block diagram showing the structure of a LCD device of embodiment 2.

FIG. 7 is a timing chart illustrating an operation example of a scan-line shift control signal generating circuit.

FIG. 8 illustrates the wire loads of the scan-line control signal lines.

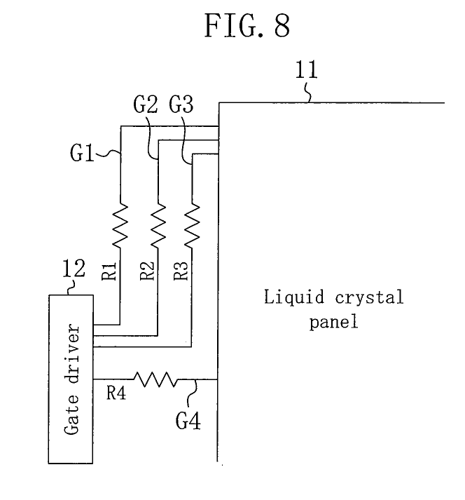

### DETAILED DESCRIPTION

Hereinafter, embodiments are described with reference to the drawings. It should be noted that elements having substantially the same functions are denoted by the same reference numerals and are not redundantly described.

### Embodiment 1

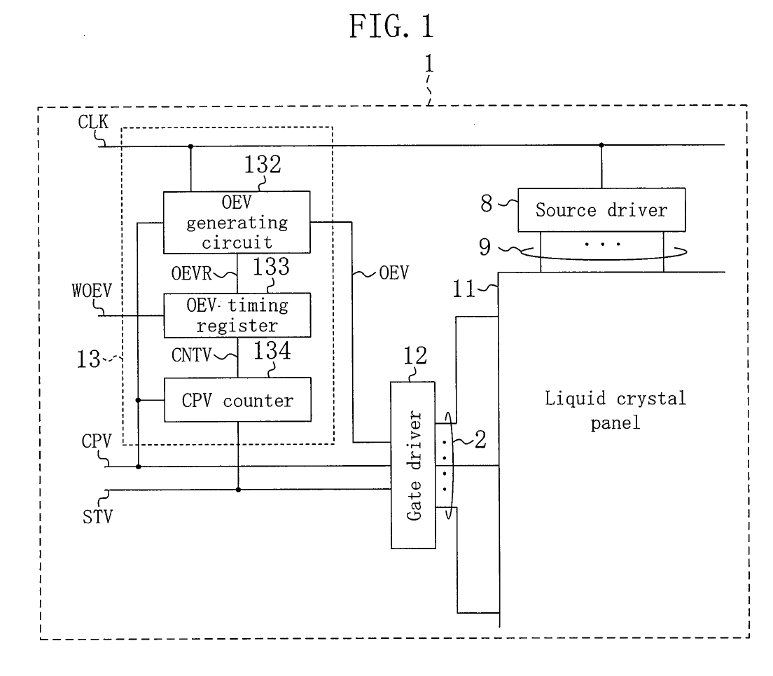

FIG. 1 is a block diagram showing the structure of a LCD device of embodiment 1. In FIG. 1, the LCD device 1 includes an active matrix liquid crystal panel 11 controlled by TFTs, a gate driver 12, a source driver 8, and a timing control circuit 13. A liquid crystal panel controller of this embodiment includes at least the gate driver 12 and the timing control circuit 13.

The liquid crystal panel 11 includes pixels arranged in rows and columns. Each of the pixels is formed by a pixel capacitor which stores a voltage for controlling the orientation of liquid crystal molecules and a TFT for controlling the inflow and outflow of the charge in the pixel capacitor.

The gate driver 12 has a plurality of output terminals, each of which is connected to corresponding one of scan-line control signal lines 2 of the liquid crystal panel 11. The TFTs of the liquid crystal panel 11 are each have a gate terminal connected to a corresponding scan line electrode and is controlled by a scan-line control signal output from the gate driver 12. The source driver 8 is connected to signal-line control signal lines 9 of the liquid crystal panel 11 to output gray level voltages. The TFTs of the liquid crystal panel 11 each have a source terminal connected to a corresponding data line electrode and have a pixel electrode to which a gray level voltage output from the source driver 8 is applied while the TFT is ON. In other words, a gray level voltage output from the source driver 8 is retained in the pixel capacitor of one line in which the scan line electrodes are ON. Voltages of desired gray levels to be displayed in respective pixels are written while the output of the gate driver 12 is shifted such that the scan line electrodes are sequentially turned on, whereby an image is displayed on the liquid crystal panel 11.

The gate driver 12 receives scan-line shift clock signal CPV and scan-line shift start signal STV which control the shift operation. When the gate driver 12 outputs from the respective output terminals panel control pulses for turning on the TFTs of the liquid crystal panel 11, the output terminals from which the panel control pulses are output are sequentially shifted according to scan-line shift clock signal CPV. Meanwhile, output enable signal OEV generated by the timing control circuit 13 is also input to the gate driver 12. Output enable signal OEV is for controlling the output timing of the pulse control pulses and includes an enable control pulse which enables the pulse control pulses to be output. Output enable signal OEV serves to prevent panel control pulses of adjacent scan lines from overlapping.

The timing control circuit 13 includes an OEV generating circuit 132, an OEV timing register 133, and a CPV counter 134. The timing control circuit 13 receives scan-line shift clock signal CPV, scan-line shift start signal STV, control clock signal CLK and OEV timing write signal WOEV and outputs output enable signal OEV. Control clock signal CLK is an operation reference clock signal for the timing control circuit 13. Alternatively, the timing control circuit 13 may generate a separate operation clock signal for the source driver 8, though in the structure of FIG. 1 control clock signal CLK is also used as the operation reference clock signal of the source driver 8. OEV timing write signal WOEV is a signal which supplies timing data for output enable signal OEV.

In the timing control circuit 13, the CPV counter 134 counts scan-line shift clock signal CPV to output counted value CNTV to the OEV timing register 133. Based on counted value CNTV, it is possible to identify how many times the output of the gate driver 12 is shifted, i.e., to identify from which output terminal a panel control pulse is output. The OEV timing register 133 determines OEV rise timing data OEVR based on count value CNTV output from the CPV counter 134 and the timing data represented by OEV timing write signal WOEV, and outputs the determined data OEVR to the OEV generating circuit 132. The OEV generating circuit 132 receives OEV rise timing data OEVR from the OEV timing register 133 and controls the timing of rising of output enable signal OEV according to OEV rise timing data OEVR. Namely, the pulse width of the enable control pulse included in output enable signal OEV is adjusted based on data OEVR. Thus, the pulse width of the enable control pulse is adjusted in accordance with the output terminal of the gate driver 12 identified based on count value CNTV. Output enable signal OEV generated by the OEV generating circuit 132 is supplied to the gate driver 12.

In summary, in the timing control circuit 13, the rising time of output enable signal OEV is controlled based on count value CNTV of scan-line shift clock signal CPV such that enable control pulses having different pulse widths are set for the output terminals of the gate driver 12. Namely, the timing control circuit 13 can adjust the pulse width of the enable control pulse for each of the output terminals of the gate driver 12.

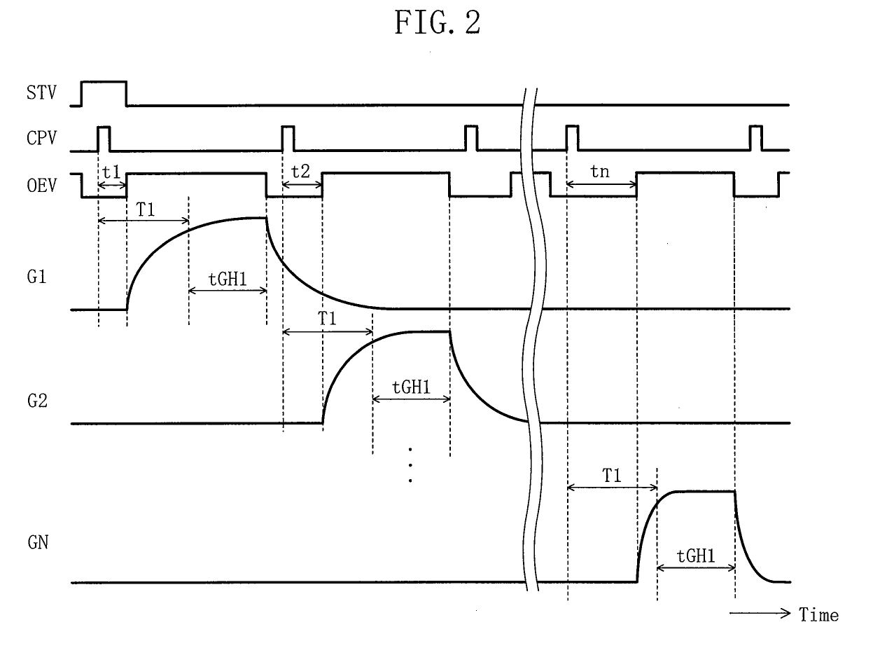

FIG. 2 is a timing chart illustrating an operation example of the LCD device of embodiment 1. FIG. 2 shows transitions of scan-line shift start signal STV, scan-line shift clock signal CPV, output enable signal OEV, and scan-line control signals G1, G2, . . . , GN (signals transmitted through the scan-line control signal lines 2) over time.

The scan-line control signals G1, G2, . . . , GN have different rising times due to their different wire loads. In the example illustrated in FIG. 2, the scan-line control signal G1 makes the slowest rising, and the scan-line control signal GN makes the fastest rising. To compensate this difference, in this embodiment, the interval between the rise timing of scan-line shift clock signal CPV and the rise timing of output enable signal OEV is varied among scan-line control signals G1, G2, . . . , GN (t1, t2, . . . , tn). In other words, in output enable signal OEV, the pulse width of the enable control pulse that enables a panel control pulse to be output (the period where OEV is “H”) is varied among scan lines, i.e., among the output terminals of the gate driver 12. With such a varying pulse width, in scan-line control signals G1, G2, . . . , GN, the interval between the rise timing of scan-line shift clock signal CPV and the timing of the control signals reaching the ON level of the TFTs is constant (T1). As a result, scan-line control signals G1, G2, . . . , GN have equal pulse widths (tGH1). Preferably, the enable control pulse may be adjusted so as to have a longer pulse width as the length of the scan-line control signal line 2 connected to a corresponding output terminal becomes greater.

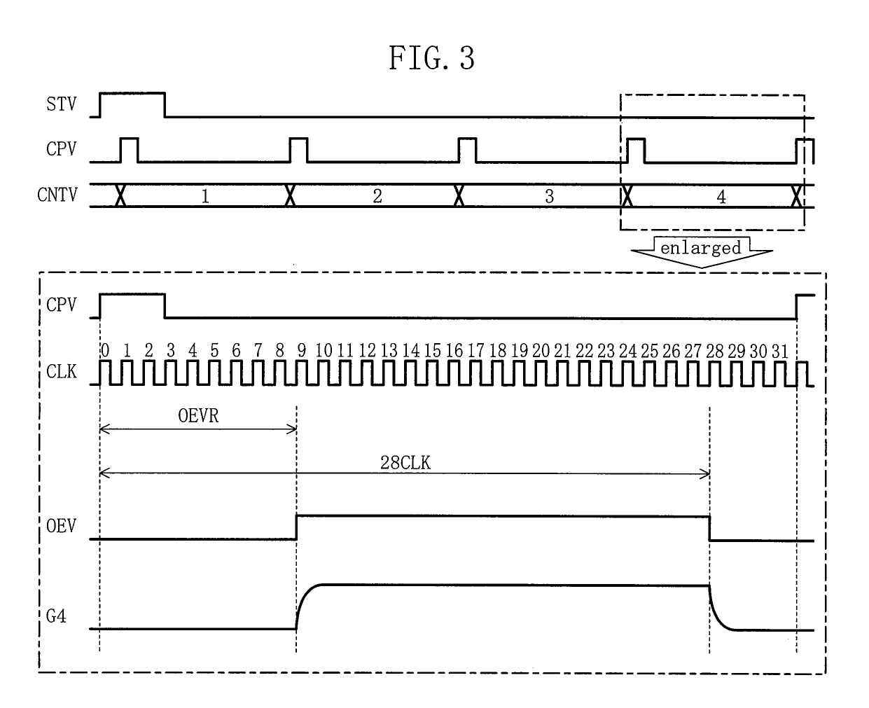

A method for generating output enable signal OEV in the timing control circuit 13 is now specifically described with reference to FIG. 3. In the example shown in FIG. 3, one cycle of scan-line shift clock signal CPV is equal to 32 clocks of control clock signal CLK, and the fall timing of output enable signal OEV occurs 28 clocks after the rise of scan-line shift clock signal CPV.

Now consider that, in scan-line control signal G4, the rise timing of output enable signal OEV, i.e., the start timing of the enable control pulse, occurs 9 clocks after the rise timing of scan-line shift clock signal CPV. In this case, timing data “9” is put in advance into a register of the OEV timing register 133 corresponding to scan-line control signal G4 by OEV timing write signal WOEV.

The CPV counter 134 receives scan-line shift start signal STV to start counting scan-line shift clock signal CPV. When the CPV counter 134 reaches “4” corresponding to scan-line control signal G4, the OEV timing register 133 receives count value CNTV (“4”) to output the value of the register corresponding to scan-line control signal G4 (in this example, “9”) as timing data OEVR to the OEV generating circuit 132. The OEV generating circuit 132 starts counting control clock signal CLK at the rise of scan-line shift clock signal CPV and then starts outputting an enable control pulse in output enable signal OEV at the timing of the 9th clock of control clock signal CLK. Thereafter, the enable control pulse ends at the timing of the 28th clock of control clock signal CLK. In this way, the enable control pulse for scan-line control signal G4 is generated.

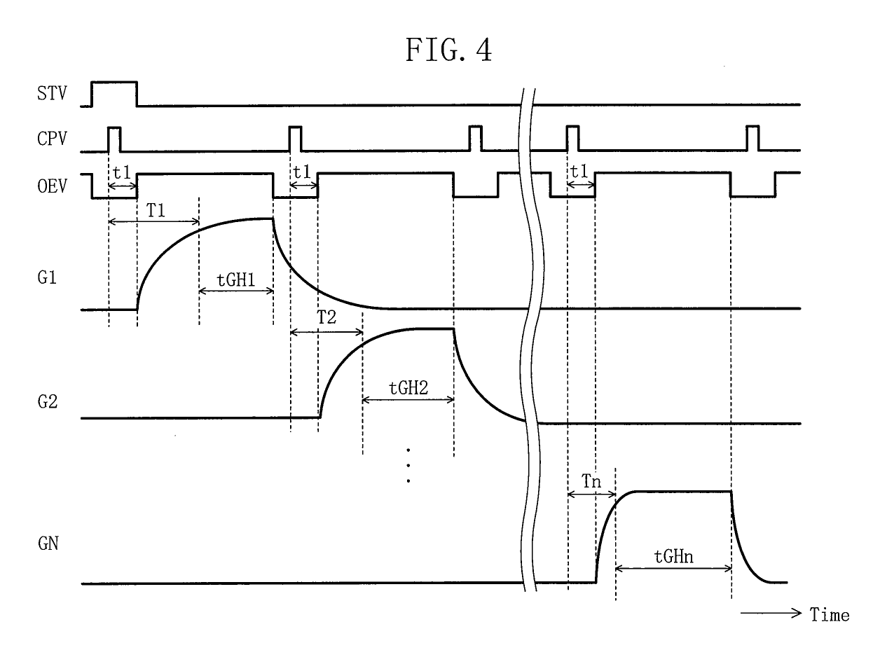

FIG. 4 is a timing chart of a comparative operation example where the pulse width of the enable control pulse of output enable signal OEV is constant. In the example of FIG. 4, among scan-line control signals G1, G2, . . . , GN, the interval between the rise timing of scan-line shift clock signal CPV and the timing of the control signals reaching the ON level of the TFTs is varying (T1>T2>Tn). Accordingly, scan-line control signals G1, G2, . . . , GN fail to have equal pulse widths (tGH1<tGH2<tGHn). As a result, an image displayed over the liquid crystal panel 11 has unevenness, which deteriorates the display quality. This disadvantage can be dismissed by the present embodiment.

A method for determining timing data OEVR is now described.

Now consider a case where the frequency of control clock signal CLK is 200 MHz (cycle: 5 nS), and the maximum line delay difference among the output terminals of the gate driver 12 is 100 nS (actual measurement or simulated value in designing). In this case, the line delay difference between the output terminal with the smallest line delay (i.e., with the shortest line to the scan line electrode) and the output terminal with the largest line delay (i.e., with the longest line to the scan line electrode) is equal to 20 clocks of control clock signal CLK. To equalize the pulse widths applied to the scan line electrodes, for example, the pulse width for the output terminal with the largest line delay can be a reference to which the pulse widths for the other output terminals are adjusted. In this case, for example, the output terminals of the gate driver 12 are sorted into 21 groups in accordance with the largeness of the line delay, and timing data OEVR “0” to “20” are allocated to the groups of output terminals in a descending order in terms of the largeness of the line delay. As a result, the enable control pulse has the largest pulse width for the output terminal with the largest line delay but the smallest pulse width for the output terminal with the smallest line delay. The difference in pulse width is equal to 20 clocks of control clock signal CLK.

The number of scan lines in a liquid crystal panel is, for example, 720 for HDTV and 1080 for Full-HDTV. In the case of using gate drivers of 270-channel output, HDTV requires 3 gate drivers, and Full-HDTV requires 4 gate drivers.

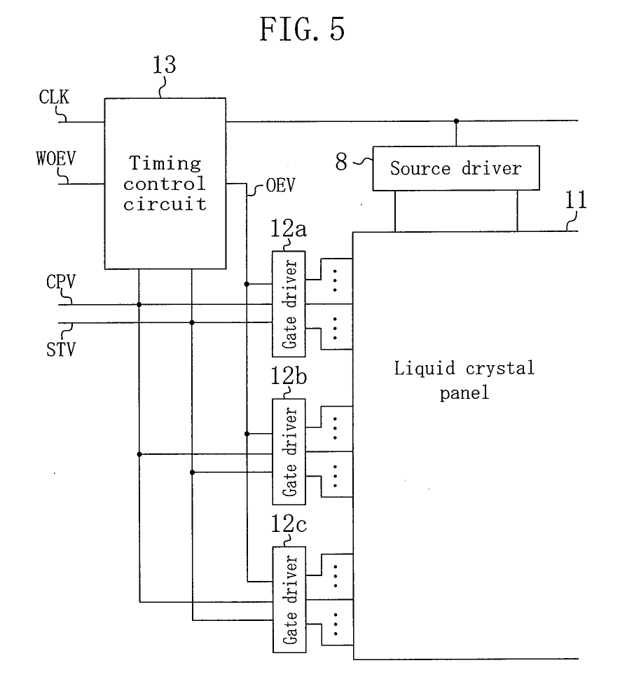

FIG. 5 shows a structure example including a plurality of gate drivers 12a, 12b, 12c. In the case of HDTV, all of the output terminals of the 3 gate drivers are sorted into 21 groups, each group including about 35 terminals, and timing data OEVR (“0” to “20”) are allocated to these groups as previously described. In the case of Full-HDTV, all of the output terminals of the 4 gate drivers are sorted into 21 groups, each group including about 52 terminals, and timing data OEVR (“0” to “20”) are allocated to these groups as previously described.

In summary, according to this embodiment, the pulse width of the enable control pulse in the output enable signal which is applied to the gate driver is variable for respective output terminals of the gate driver. Therefore, even if the scan-line control signal lines have different lengths, the control signals applied by the gate driver to the liquid crystal panel have equal pulse widths. With such an arrangement, occurrence of unevenness in display over the liquid crystal panel can be prevented.

The output terminals of the gate driver in the above example are sorted into 21 groups, to which the present invention is not limited, but the manner of sorting the output terminals may alternatively be in various forms in accordance with, for example, the number of output terminals one gate driver has, the clock frequency of the control clock signal, etc. The groups of output terminals in the above example include substantially equal number of terminals, to which the present invention is not limited, but in some cases may preferably include different numbers of terminals according to the form of a liquid crystal panel used, for example, in order to achieve better characteristics. If the gate driver includes a small number of gate drivers, the pulse width of the enable control pulse may be adjusted for respective output terminals.

### Embodiment 2

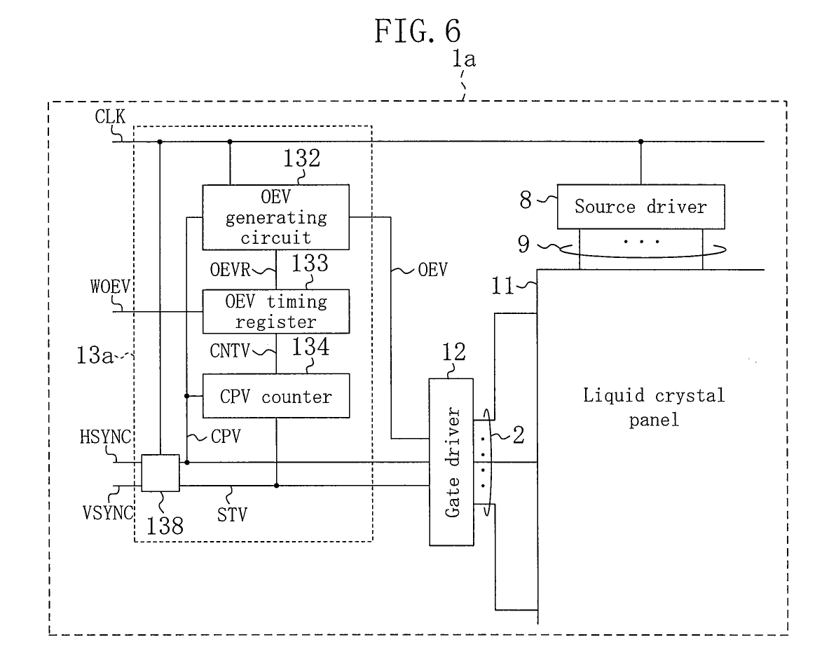

FIG. 6 is a block diagram showing the structure of a LCD device of embodiment 2. The LCD device 1a shown in FIG. 6 has substantially the same structure as that of the LCD device 1 of FIG. 1, and the operation of the LCD device 1a is substantially the same as that of the LCD device 1, except for the structure of the timing control circuit 13a.

The timing control circuit 13a includes a scan-line shift control signal generating circuit 138 which receives vertical synchronization signal VSYNC and horizontal synchronization signal HSYNC for the liquid crystal panel 11 and generates scan-line shift start signal STV and scan-line shift clock signal CPV. Vertical synchronization signal VSYNC is in synchronization with the cycle of rewriting one frame of the liquid crystal panel 11, which is 60 Hz in standard mode and 120 Hz in double-speed mode. Horizontal synchronization signal HSYNC is for controlling the cycle of writing gray level data for one scan line of the liquid crystal panel 11.

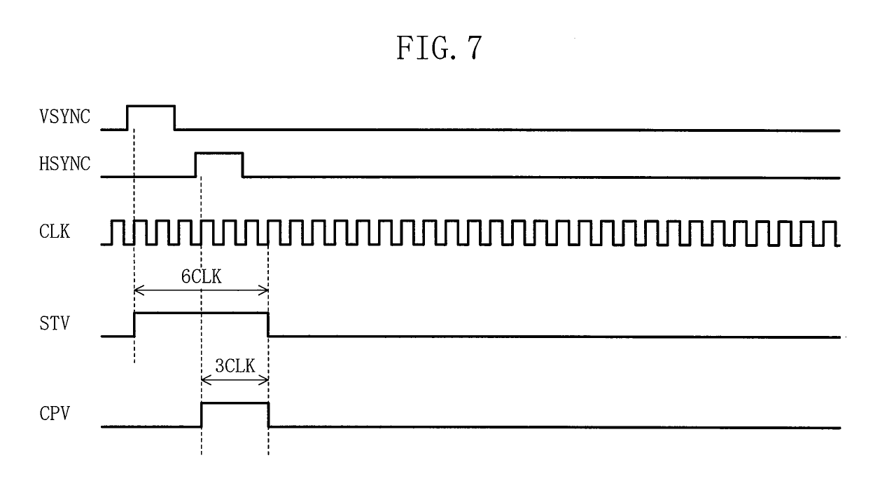

FIG. 7 is a timing chart illustrating an operation example of the scan-line shift control signal generating circuit 138. When receiving a pulse of vertical synchronization signal VSYNC, the scan-line shift control signal generating circuit 138 generates scan-line shift start signal STV having a pulse width equal to, for example, 6 clocks of control clock signal CLK. When receiving a pulse of horizontal synchronization signal HSYNC, the scan-line shift control signal generating circuit 138 generates scan-line shift clock signal CPV having a pulse width equal to, for example, 3 clocks of control clock signal CLK. The timing control circuit 13a uses scan-line shift start signal STV and scan-line shift clock signal CPV generated in such a way by the scan-line shift control signal generating circuit 138 to generate output enable signal OEV as in embodiment 1.

The LCD devices as described in the above examples, and possible variations thereof within the extent of the present invention, can prevent occurrence of unevenness in display and are therefore useful for large-screen, high-definition display devices.

What is claimed is:

1. A liquid crystal display device, comprising:
an active matrix liquid crystal panel;
a gate driver having a plurality of output terminals connected to scan-line control signal lines of the liquid crystal panel, the gate driver outputting from the output terminals a panel control pulse for turning on a thin film transistor of the liquid crystal panel; and
a timing control circuit outputting to the gate driver an output enable signal for controlling an output timing of the panel control pulse,
wherein the output enable signal includes an enable control pulse for enabling the panel control pulse to be output, and
the timing control circuit is capable of adjusting a pulse width of the enable control pulse in accordance with the output terminals of the gate driver.

2. The liquid crystal display device of claim 1, wherein:
the timing control circuit includes a counter for counting a scan-line shift clock signal; and
the timing control circuit identifies an output terminal of the gate driver from which the panel control pulse is output based on a value counted by the counter and adjusts the pulse width of the enable control pulse in accordance with the identified output terminal.

3. The liquid crystal display device of claim 2, wherein the timing control circuit receives the scan-line shift clock signal from an external device.

4. The liquid crystal display device of claim 2, wherein the timing control circuit includes a scan-line shift control signal generating circuit which receives a vertical synchronization signal and a horizontal synchronization signal for the liquid crystal panel to generate the scan-line shift clock signal.

5. The liquid crystal display device of claim 1, wherein the timing control circuit sorts the output terminals of the gate driver into groups each including two or more output terminals and adjusts the pulse width of the enable control pulse for each of the groups.

6. The liquid crystal display device of claim 1, wherein the timing control circuit adjusts the enable control pulse such that the enable control pulse has a longer pulse width as the length of a scan-line control signal line connected to a corresponding output terminal becomes greater.

7. A liquid crystal panel controller for controlling an active matrix liquid crystal panel, comprising:
a gate driver having a plurality of output terminals connected to scan-line control signal lines of the liquid crystal panel, the gate driver outputting from the output terminals a panel control pulse for turning on a thin film transistor of the liquid crystal panel; and
a timing control circuit outputting to the gate driver an output enable signal for controlling an output timing of the panel control pulse,
wherein the output enable signal includes an enable control pulse for enabling the panel control pulse to be output, and
the timing control circuit is capable of adjusting a pulse width of the enable control pulse in accordance with the output terminals of the gate driver.

8. A timing control circuit for controlling an operation timing of a gate driver that controls an active matrix liquid crystal panel,
wherein the gate driver has a plurality of output terminals connected to scan-line control signal lines of the liquid crystal panel, the gate driver outputting from the output terminals a panel control pulse for turning on a thin film transistor of the liquid crystal panel; and
wherein the timing control circuit outputs to the gate driver an output enable signal for controlling an output timing of the panel control pulse, the output enable signal including an enable control pulse for enabling the panel control pulse to be output, and
the timing control circuit is capable of adjusting a pulse width of the enable control pulse in accordance with the output terminals of the gate driver.
